(19) United States
(12) Patent Application Publication
(10) Pub. No.: US 2002/0147619 A1
(43) Pub. Date: Oct. 10, 2002

(54) Method and system for providing personal travel advice to a user

(76) Inventors: Peter Floss, Littleton, MA (US); Robert Roberts, Hudson, MA (US); Daniel P. Donovan, Lynnfield, MA (US); Laura Wills, Toronto (CA); Steve Liggett, Arlington, MA (US); Lora Kratchounova, Toronto (CA); Chris Guglietti, Wellesley, MA (US); Ognian Mihaylov, Somerville, MA (US); Steve Wasserman, Burlington, MA (US)

Correspondence Address: CESARI AND MCKENNA, LLP, 88 BLACK FALCON AVENUE, BOSTON, MA, 02210, US

(21) Appl. No.: 09/827,054

(22) Filed: Apr. 5, 2001

(51) Int. Cl. G06F 17/60

(52) U.S. Cl. 705/5

(57) ABSTRACT

A method and system for providing personal travel advice to a user is provided. The method and system includes a profiling engine that prepares a personalized profile for a particular user by gathering user-specific data regarding an individual's likes, dislikes, lifestyle, interests, activities and budget for the vacation. Several profiles for members of a group travelling together can be combined to obtain recommendations for the group. An advice engine combines information from various expert knowledge bases to provide recommended travel destinations. The profiles may also be used to check a destination for its appropriateness, and to request a similar destination to one enjoyed previously by the individual or the group.

### BACKGROUND OF THE INVENTION

1. Field of the Invention

The present invention relates to providing personalized travel advice, and in particular, to a method and system for customizing travel information and ultimately making travel arrangements using a computer.

2. Background Information

The widespread availability of instant information and communication over the Internet is revolutionizing ways of doing business, such as the travel business. No longer must potential travelers make conventional telephone calls to airlines or travel agents and wait for an agent to assist the traveler in selecting destinations, flights, times and fares, and accommodations. Hotels, airlines and other travel providers advertise and sell their products over the Internet to computer users with web access for making arrangements electronically.

Unfortunately, the experience of making travel arrangements over the Internet is not always satisfactory. In some regards, there is too much information to sort through for the average, busy consumer. There are many different web sites for airline reservations and ticketing, car rental, hotels, vacation locations, cruises and other leisure activities. Searching through these sites can be extraordinarily time consuming and possibly confusing. Even though this information is available, a customer or family may prefer to begin by planning a destination that is best suited to their budget, their desired activities, the culture, the climate, the availability of outdoor activities and sports, that they prefer.

It has been known to provide vacation information and even some suggestions with destination information. However, this is not customized for the individual traveler or family or other group of persons who may be traveling together to find the optimum destination for that individual or the group.

Accordingly, there remains a need for a web site paradigm, that provides travel advice that is personalized for an individual or customized for a group of travelers allowing them to select from destinations which have been ranked according to their own preferences. There is a further need for a method and system for providing travel advice that also takes budget information into account. Yet a further need exists for a travel advice service that can locate vacation destinations that are comparable to destinations that are familiar to an individual or that may have been previously enjoyed by the individual or the group.

### SUMMARY OF THE INVENTION

These and other needs are satisfied by the present invention, which is a method and system of providing personalized travel advice to a user over the Internet. The personal travel advice system employs software engines that assemble user inputs and several databases of expert knowledge and predefined sets of rules to prepare user profiles and to generate travel advice. A profiling engine prepares a profile for a particular user, or “member”. As used herein, a “member” is an individual who pays a subscription fee for the use of the travel advice method and system via the World Wide Web. In a few cases, the member may be an individual who may telephone an agent and give the required information via a voice call if, for example, the individual did not have web access. But, for the most part, the method and system is conducted over the Internet. A visitor to the system may also be able to obtain information, but typically does not have access to all of the system resources.

Building a profile involves gathering member-specific data regarding an individual's likes, dislikes and budget constraints. A profile, sometimes referred to herein as a “passport,” is customized for a particular individual based upon the data gathered. Profiling elements include characteristics involving lifestyle, personality, interests, activities, and accommodation preferences. In accordance with one aspect of the invention, the individual using the system responds to questions by assigning weighted values to a series of travel preferences. For example, a respondent weights his/her preferences about travelling to a large city versus visiting a less populated, more rural area. From the individual's responses, the profiling engine builds a unique profile for the individual.

The second aspect of the system is a vacation request program. The vacation request program assembles a primary profile of the individual requesting the travel advice. In addition, other persons may be planning to go on the proposed vacation and, thus new passports are built for those individuals, if those passports do not already exist in the system. A budget range is requested, as well as the proposed date of departure and the duration of the vacation, as well as a general region where the vacationers would like to travel. The primary interests for the vacation are rated by the respondent, and activities for the vacation are rated to indicate those which are of primary importance.

An advice engine then combines the information from the profiles, the requests is and information about destinations. It also filters out certain destinations that are not appropriate. Additional databases are used for this step as well. These databases include a database of real world knowledge such as: a destination that requires 2.5 days travel time cannot be recommended for a vacation request indicating a three-day vacation duration. A set of leisure advice rules are also applied to reduce the relevance of destinations that do not offer the requested activities because of the climate or season involved. For example, a destination which would have winter weather conditions at the travel time would not be recommended for a golf vacation.

The weighted values are then used by the advice engine in a scoring step to take into account the rated activities and interests. Budget is also factored into the score. This is used with a database of rated values for each destination. Characteristics captured about each destination can include activities, e.g. golf, beaches, key attractions, and the like. Based on all of this information, certain destinations are recommended by the advice engine and ranked for consideration by the respondent (user).

The profile and request information may be used with a number of other functions that are also provided by the system. A “Get Recommendations” function maps profiles and requests onto destinations to produce a scored and ranked set of recommended destinations, as just previously discussed. A “Destination Check” function maps profiles and a request onto specific destinations to produce a scored ranking for that destination with respect to other potential destinations. A “Someplace Similar” function maps a specific destination against the other destinations and the profiles to produce similar destinations that match many of the ratings of the input destination and selects and ranks similar destinations, (e.g., If you like New York City, you'll like L.A.).

In accordance with another aspect of the invention, a “Pick a Personality” function is provided. The “Pick a Personality” function includes personalities that are full profiles that have been pre-defined (they are not customized). The “Pick a Personality” function can be used by visitors to the site to allow visitors to make use of the site on a trial basis without paying the subscription fee that may be required for obtaining a personalized profile. The “Pick a Personality” function can also be used by members should they prefer to obtain a quick suggestion in a particular instance.

### BRIEF DESCRIPTION OF THE DRAWINGS

The invention description below refers to the accompanying drawings, of which:

FIG. 1 is a schematic block diagram illustrating one architecture for a travel advice system in accordance with one embodiment of the present invention;

FIG. 2 is a schematic block diagram of the exemplary travel advice system showing the information which is provided to the profiling engine and the advice engine in accordance with the present invention;

FIGS. 3A and 3B together form a flow chart of the steps performed to build a profile in accordance with the present invention;

FIG. 4A is a screen shot of the user interface for the profile preparation function of the present invention;

FIG. 4B is a screen shot in which the user is requested to provide weighted values regarding certain information;

FIG. 5A is a screen shot regarding the interests as rated by the user;

FIG. 5B is a screen shot regarding the activities as rated by the user;

FIG. 6 is a flow chart of the steps followed in accordance with the method of the present invention to obtain a vacation request;

FIGS. 7A through 7C are screen shots of the vacation request user interfaces including the rating for the top combined interests of the user in accordance with the present invention;

FIGS. 8A and 8B are screen shots illustrating the vacation recommendations in accordance with the present invention;

FIG. 9 is a schematic block diagram of the information mapped on to the various destinations in an illustrative embodiment of the invention;

FIG. 10 is a schematic block diagram of the various inputs in profiling and destination preparation in accordance with the present invention;

FIG. 11 provides further details about the profile and destination profiling destination step;

FIG. 12 is a schematic illustration regarding the filtering step;

FIG. 13is schematic illustration of the adjustments made in the profile and destination preparation step;

FIG. 14 is a schematic illustration providing further details of the scoring step;

FIG. 15A is a screen shot illustrating the “Destination Check” mode;

FIG. 15B illustrates the personalities that may be selected in accordance with one embodiment of the invention;

FIG. 15C illustrates the “Destination Check” results;

FIG. 16 is a flow chart illustrating the “Someplace Similar” mode of the invention; and

FIG. 17 is a screen shot illustrating the “Someplace Similar” mode of the present invention.

### DETAILED DESCRIPTION OF AN ILLUSTRATIVE EMBODIMENT

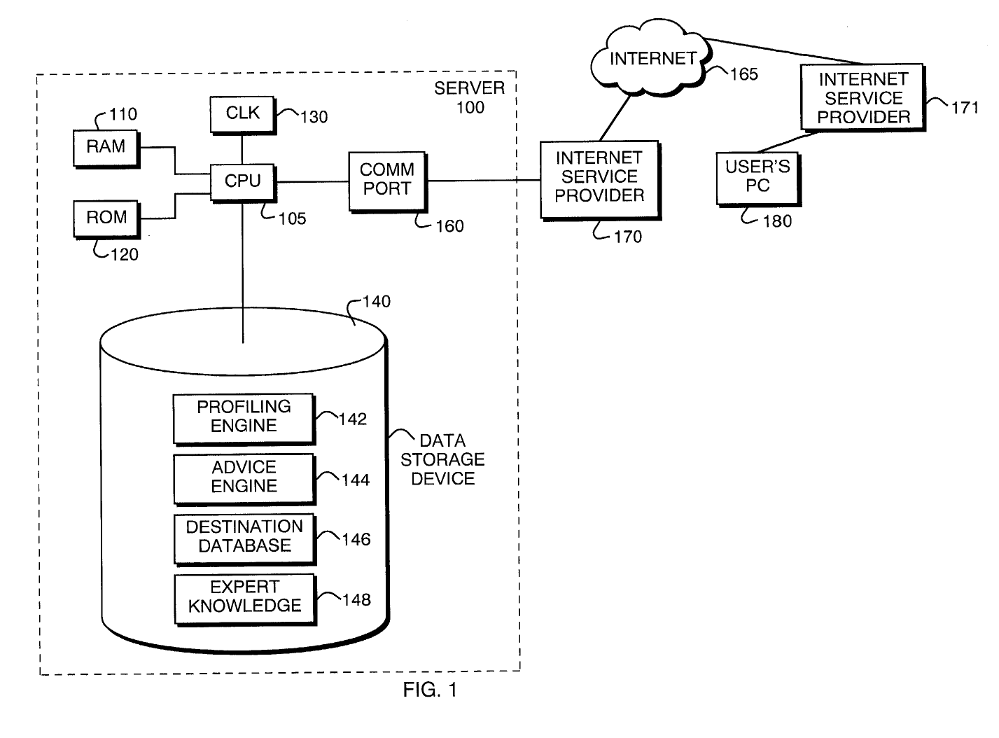

FIG. 1 is a block diagram showing the architecture of an illustrative travel advice system server 100. It should be understood that other architectures could serve equally well while remaining in the scope of the present invention. The travel advice central server 100 includes certain standard hardware components, such as a central processing unit (CPU) 105, a random access memory (RAM) 110, a read only memory (ROM) 120, a clock 130, a data storage device 140 and a communications port 160. The data storage device 140 includes the programs and databases employed in the method of the present invention. A profiling engine 142 is used to generate the user profiles. An advice engine 144 is used to produce the vacation advice regarding destinations. A destination database 146 and an expert knowledge database 148 support the advice engine. The travel recommendations produced in accordance with the method and system of the present invention may be used by an individual who can interface with the system via the Internet 165 using Internet service providers 170, 171 with which the user has access via personal computer (PC) 180. It should be understood, however, that the user might interface with the system though a different medium, which may include wireless, wireline or other information technology, while remaining within the scope of the present invention.

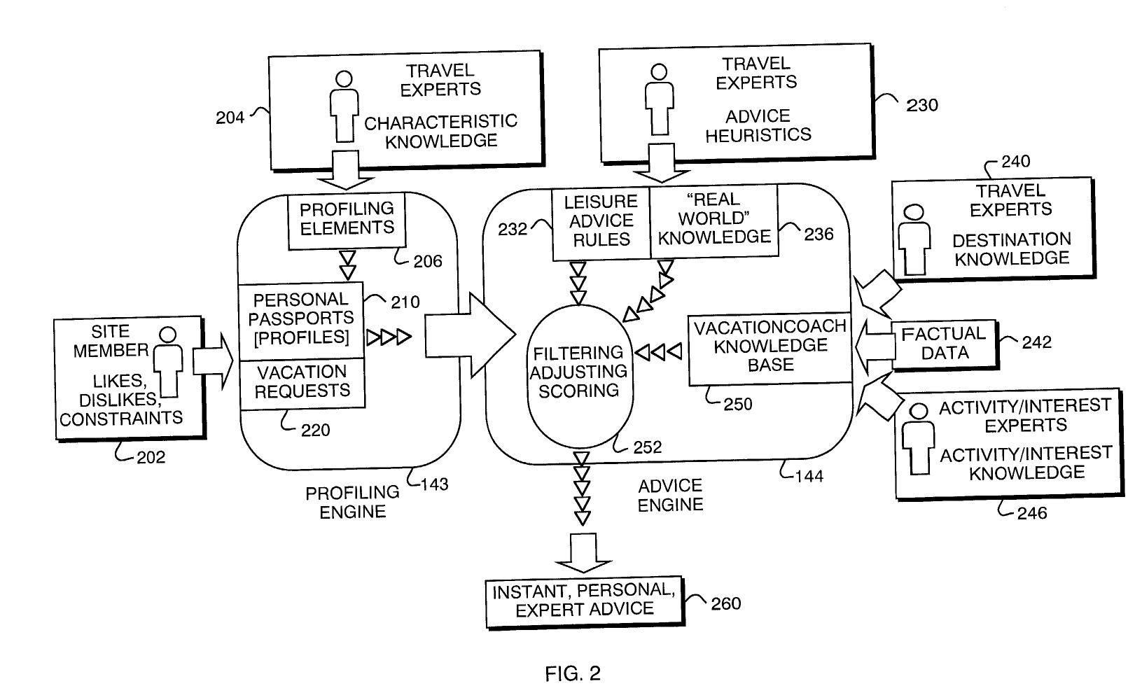

The overall paradigm for the method and system for providing travel advice of the present invention is illustrated schematically in FIG. 2. The two primary components of the system as illustrated in FIG. 2 are the profiling engine 142 which produces the personalized user profiles and the advice engine 144 which produces the customized travel recommendations. The profiling engine 142 gathers information from a site member represented by block 202. The site member 202 inputs his or her own individual likes, dislikes and constraints. Additionally, the profiling engine 142 receives information from a travel expert database including characteristic knowledge 204. These characteristics are selected if relevant to a particular profile and become profiling elements 206. For example, when a user enters his/her age, characteristics for that age are taken into account. The information from the site member 202 and the profiling elements 206 are combined to provide a personal profile 210. Information is also given about the type of vacation desired in a vacation request 220. These aspects of the invention are described in further detail hereinafter.

The advice engine 144 gathers information from a variety of sources. As shown in block 230, travel expert advice and advice heuristics are provided to develop leisure advice rules 232 and real world knowledge 236. Travel expert advice concerning knowledge about the individual destinations in a destination knowledge database 240 is also provided to the advice engine 144. Factual data 242 is provided. Expert activity and interest knowledge 246 is provided. The information from blocks 242 and 246 combine to form a knowledge database 250 for that profile/request combination. A filtering and adjusting and scoring step 252 ultimately leads to the instant personal expert advice 260, as illustrated in FIG. 2.

Building a Profile

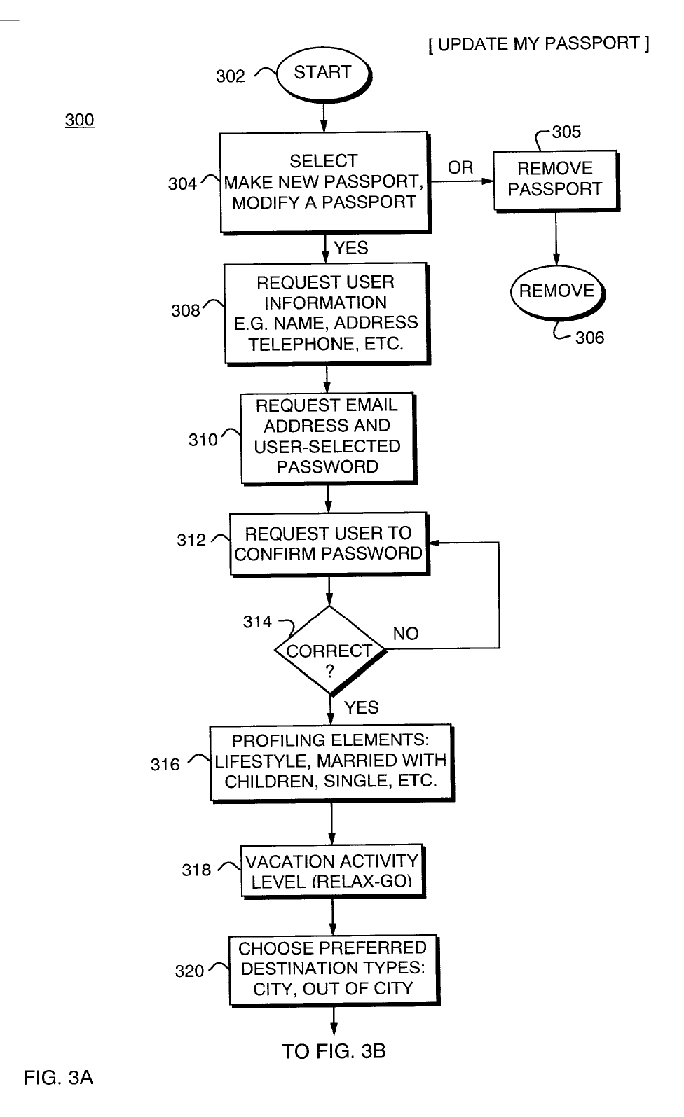

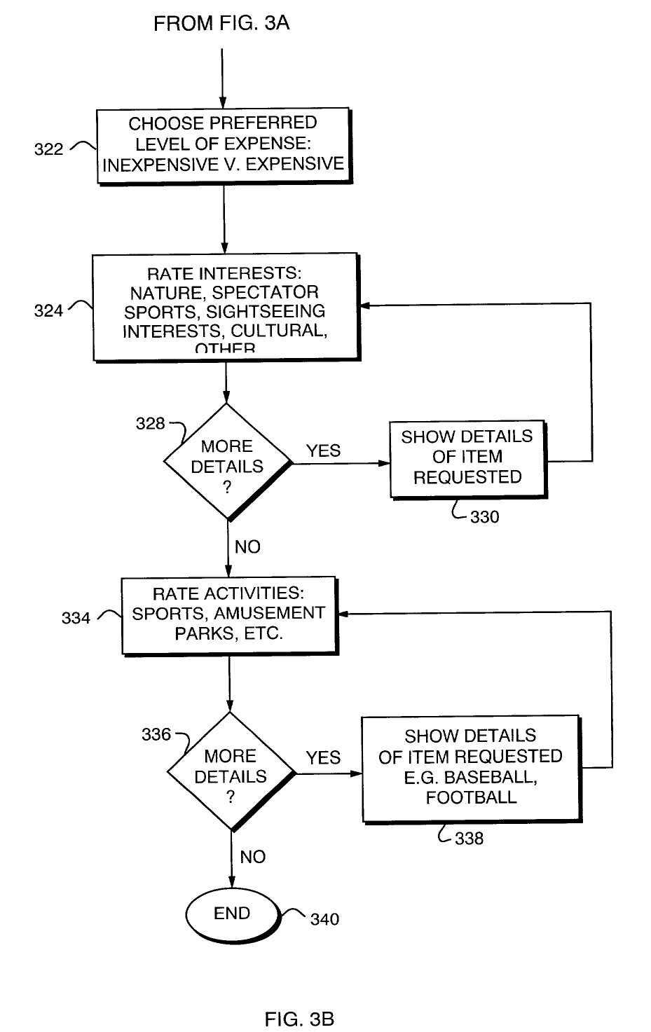

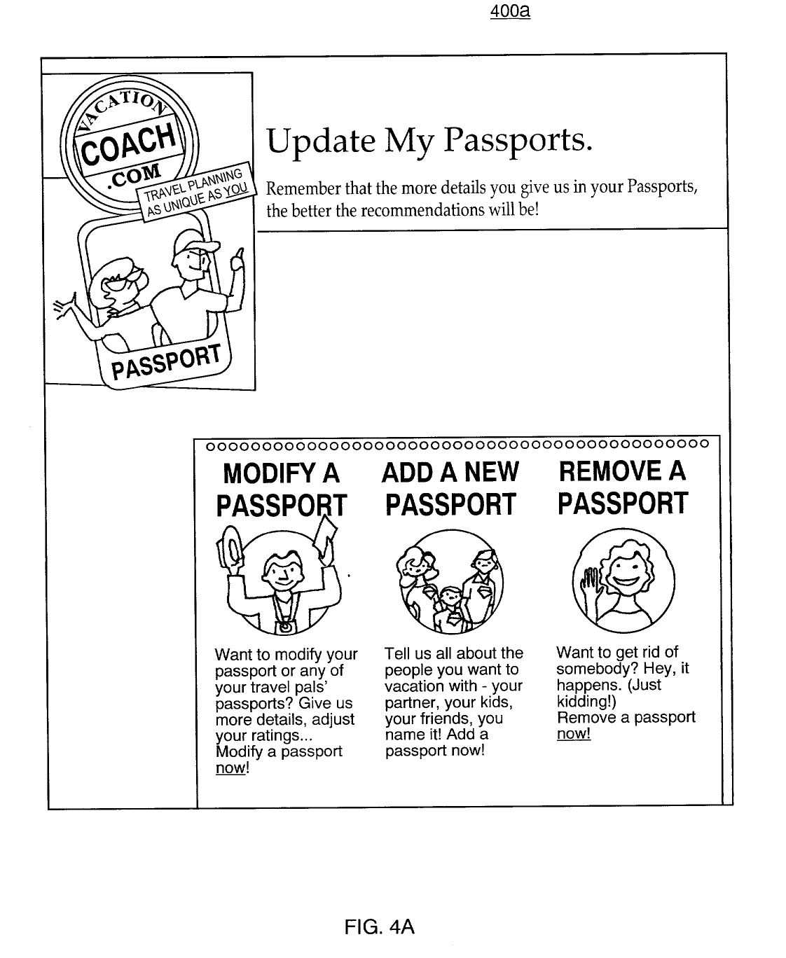

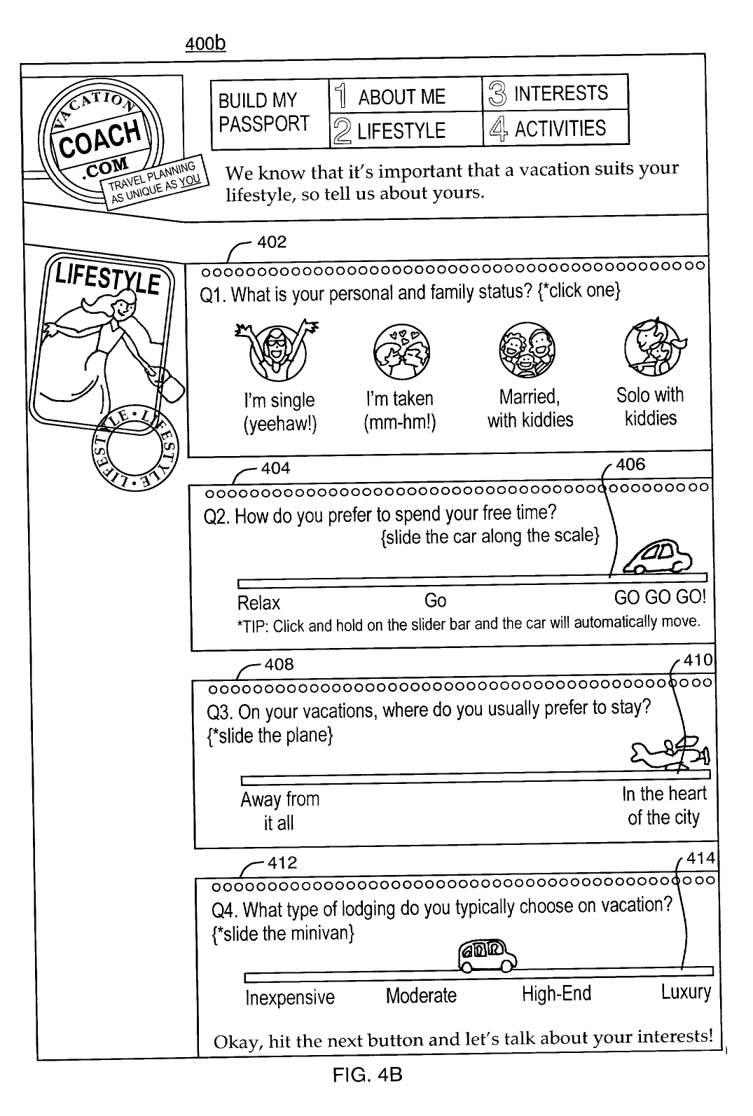

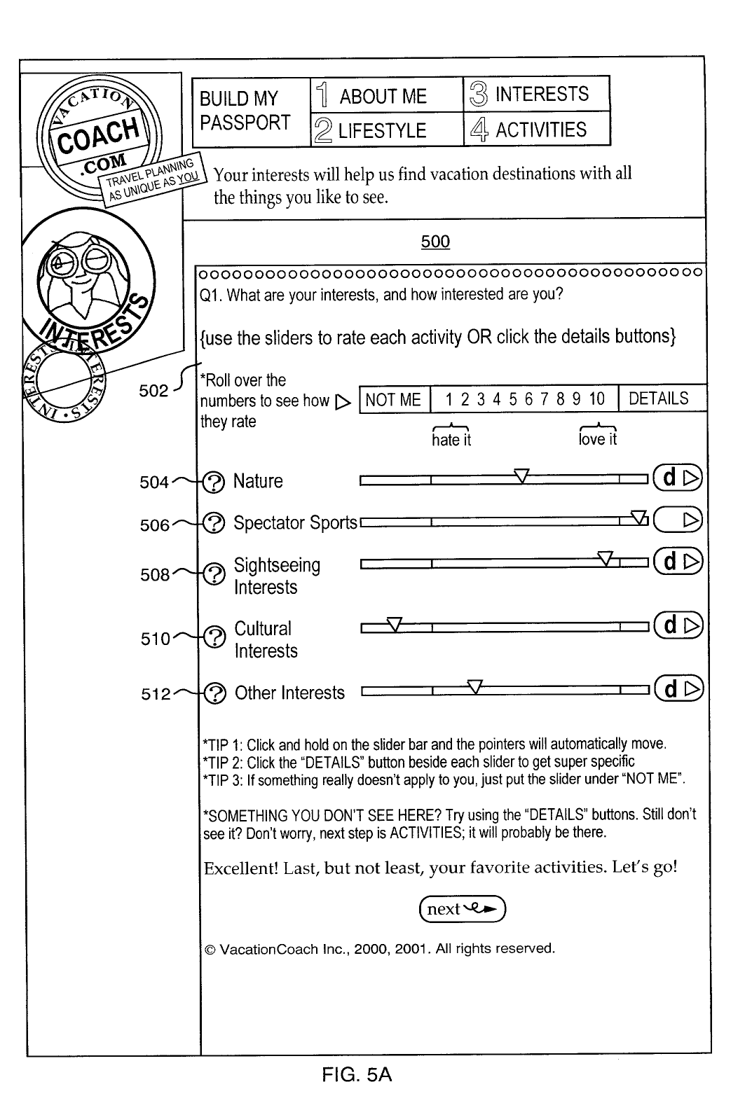

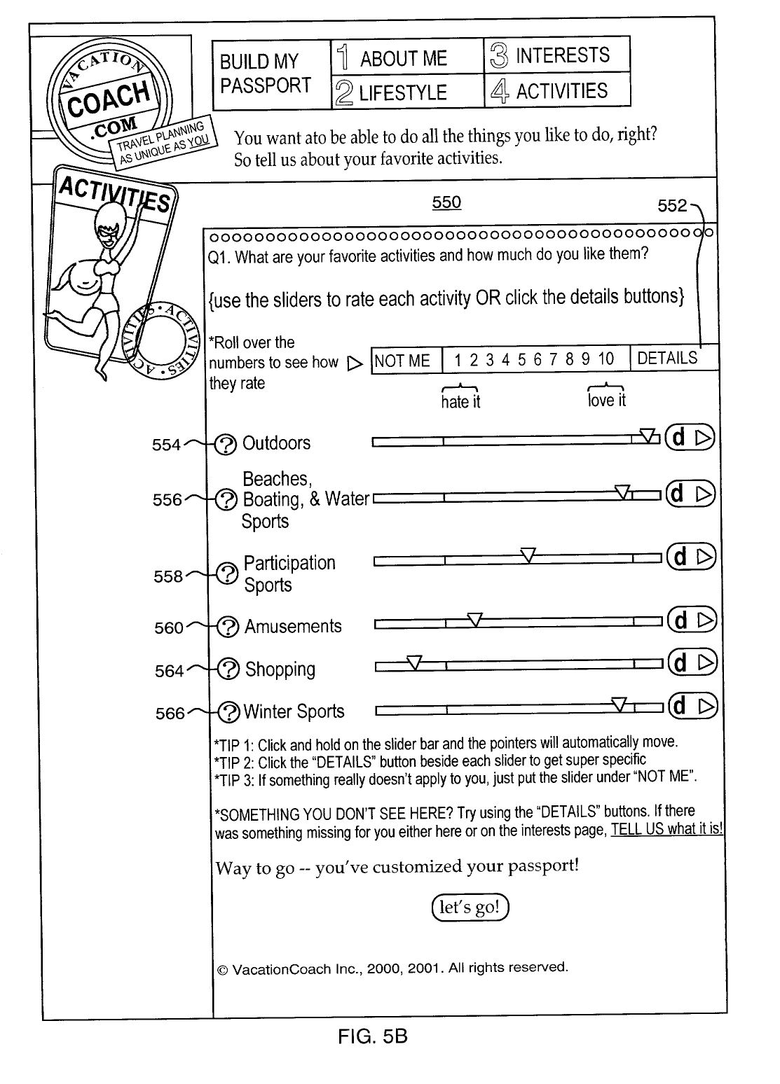

Creating the personal passport profile 210 may be further understood with reference to the flow chart of FIGS. 3A and 3B. The user interface for obtaining this information via the Internet site is illustrated in the screen shots of FIGS. 4A, 4B, 5A and 5B. Referring to FIGS. 3A and 3B, the flow chart 300 begins at step 302. The user is requested to choose to either make a new passport or modify an existing passport, 304. Steps 305 and 306 provide the user the opportunity to remove a passport. The user interface for making this selection is illustrated in FIG. 4A in block 400a.

Next, as illustrated in step 308, the user is requested to provide basic information such as name, address and age. The primary user is requested to provide an email address and to select a password, 310, and to confirm the password, 312. The password is checked against the original input, 314. Step 316 requests profiling elements regarding the lifestyle of the user (e.g., married with children, single).

This user interface for requesting this information is illustrated in the screen shot 400b in FIG. 4B, at question 1 (402). Step 318 (FIG. 3A) prompts the user to chose a preferred destination type, which is also illustrated at block 404 of the screen shot 400b of FIG. 4B. A sliding scale 406 is provided which allows the user to indicate a weighted response for the type of vacation desired. The user may slide an indicator such as car (using his/her cursor) along the scale 406 to provide a weighted response to the question in step 318. Step 320 of FIG. 3A requests the user to chose a preferred destination type. The user interface of screen shot 400b (FIG. 4B) allows a range for this question ranging from “away from it all” to “in the heart of the city” as shown by the slider bar 410.

Step 322 requests that the user chose a preferred level of expense. The screen shot 400b of FIG. 4B allows for a weighted response to this question (412). Using slider bar 414, the user can provide the requested expense level ranging from inexpensive to moderate to high end to luxury.

The flow chart continues onto FIG. 3B. Favorite activities such as outdoors, beaches, boating and water are then rated by the individual to define what type of things the individual would prefer to do while on vacation. This information is then used to prepare a customized profile for a particular individual. More specifically, the user is requested to rate interests for the vacation as shown in the user interface screen shot 500 of the FIG. 5A. The interests can be rated on a sliding scale ranging from “not me” and 1-10 as shown on the scale 502. Any number of interests can be provided for the user to rate. In the illustrative embodiment, we have shown as interests for the vacation: nature 504, spectator sports 506, sight seeing interests 508, cultural interests 510 and other interests 512. As shown in steps 328 and 330 of FIG. 3B, further details can be requested and those details can be shown for a particular item.

Next, the user is asked to rate the activities for the vacation as shown in step 334 of FIG. 3B. The user interface screen shot 550 of FIG. 5B shows a sliding scale 552. The user can move the arrow on to the scale 552 to rate each of the activities, such as outdoor activities 504, beaches 506, participation sports 508, amusements 510, shopping 514 and winter sports 516. Further details can be requested as shown in steps 336 and 338. This aspect of the program ends at step 340 of FIG. 3B.

Making a Vacation Request

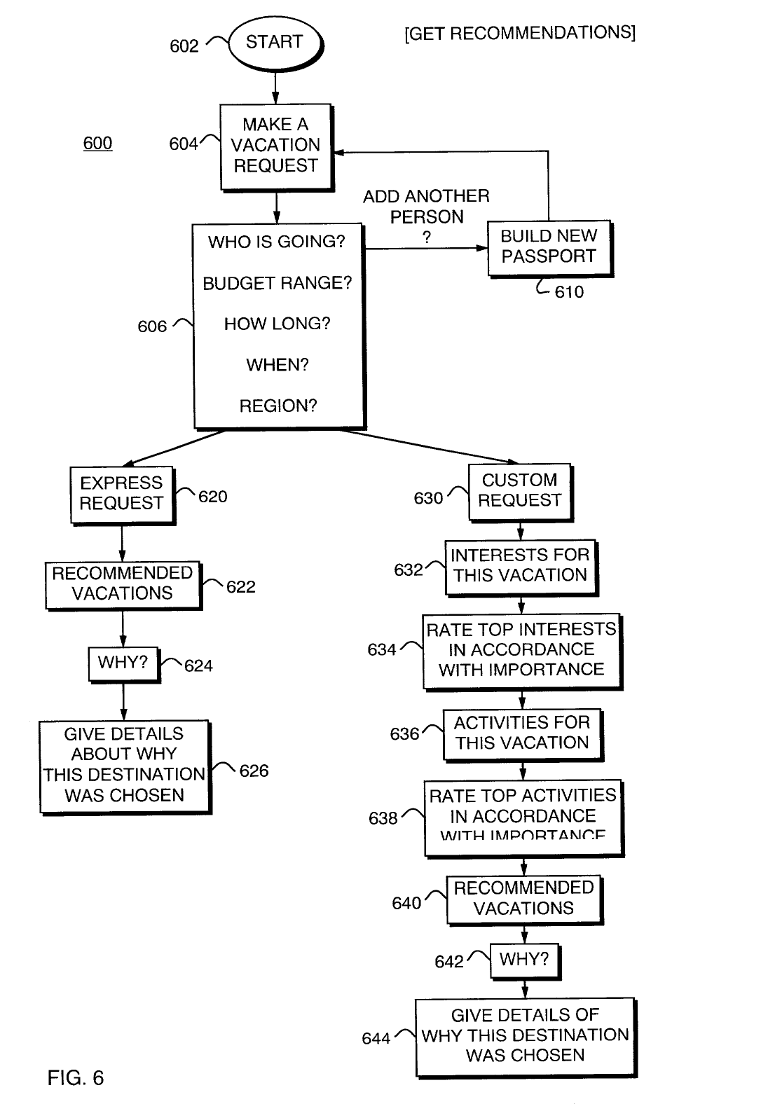

The next aspect of the system of the present invention involves making a vacation request. This includes obtaining information about the type of vacation the user desires. The steps for obtaining this information are illustrated in the flow chart 600 of FIG. 6. The program begins at step 602 and prompts the user to make a vacation request 604. The block 606 indicates other information that is requested such as budget range, length of the vacation, date of departure, and the preferred region. The preferred region can be left blank allowing for a suggestion of anywhere in the world, rather than a particular region such as Northeastern United States.

At this point of the decision tree, the program asks the user if he/she would like to use the express request mode or a custom request mode. The user may also request the system to build a new passport/profile 610 for other individuals or family members who may plan to go on this particular vacation as well. The user might choose an express request, step 620. The express request 620 is fulfilled with a set of recommended vacations as indicated by step 622. As indicated in step 624, the user can inquire as to why those particular locations were recommended by the system. Step 626 shows that details can be given about why the destination was chosen for this particular user based on the user's profile and vacation request.

The other path of the decision tree is the custom request path. A custom request is made (as shown in step 630). The user is prompted (step 632) to indicate interests for this vacation. The user is asked to rate his/her top interests in accordance with importance (634).

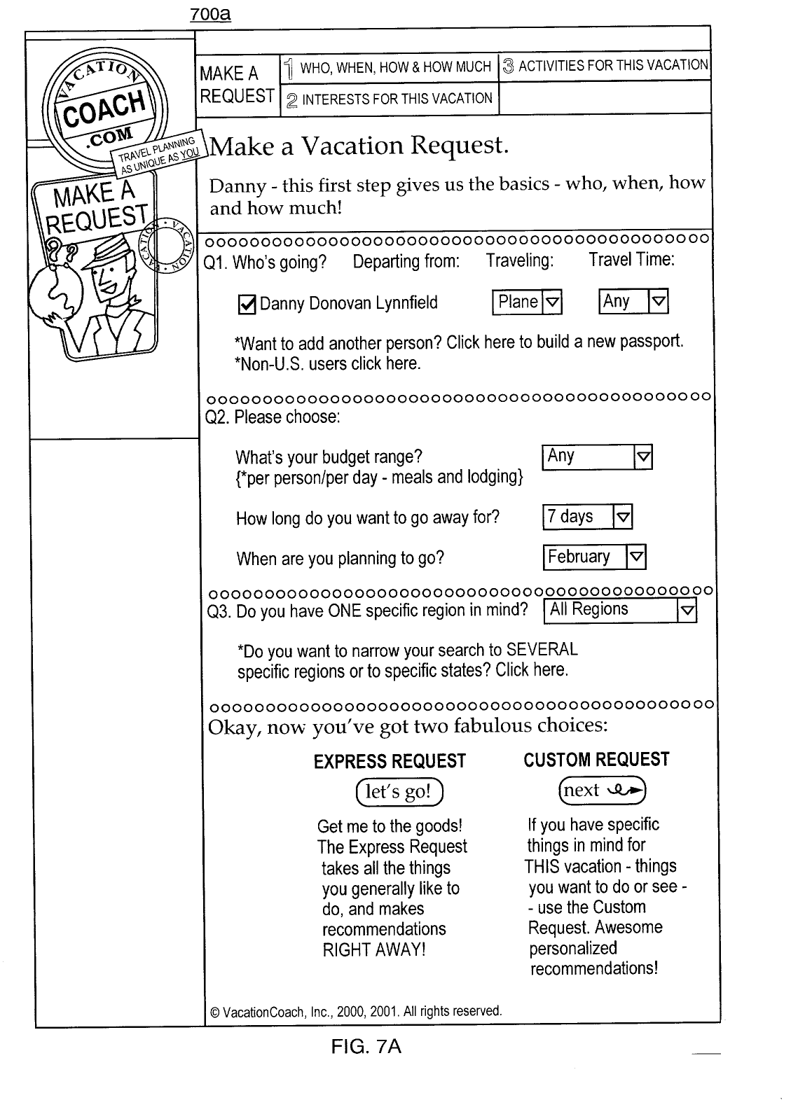

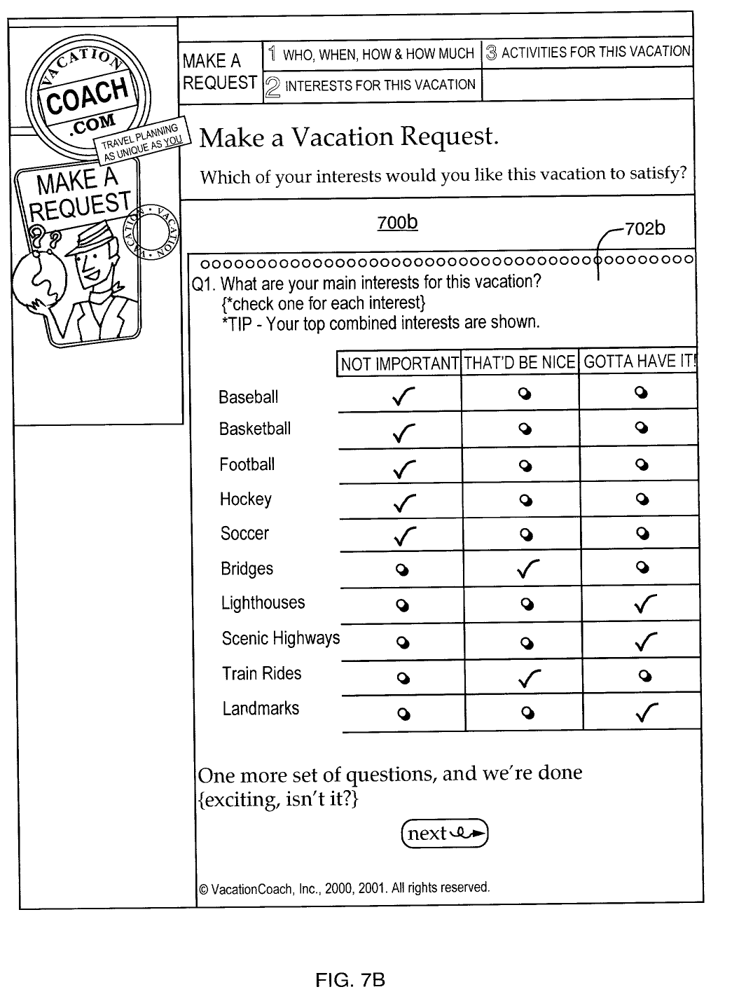

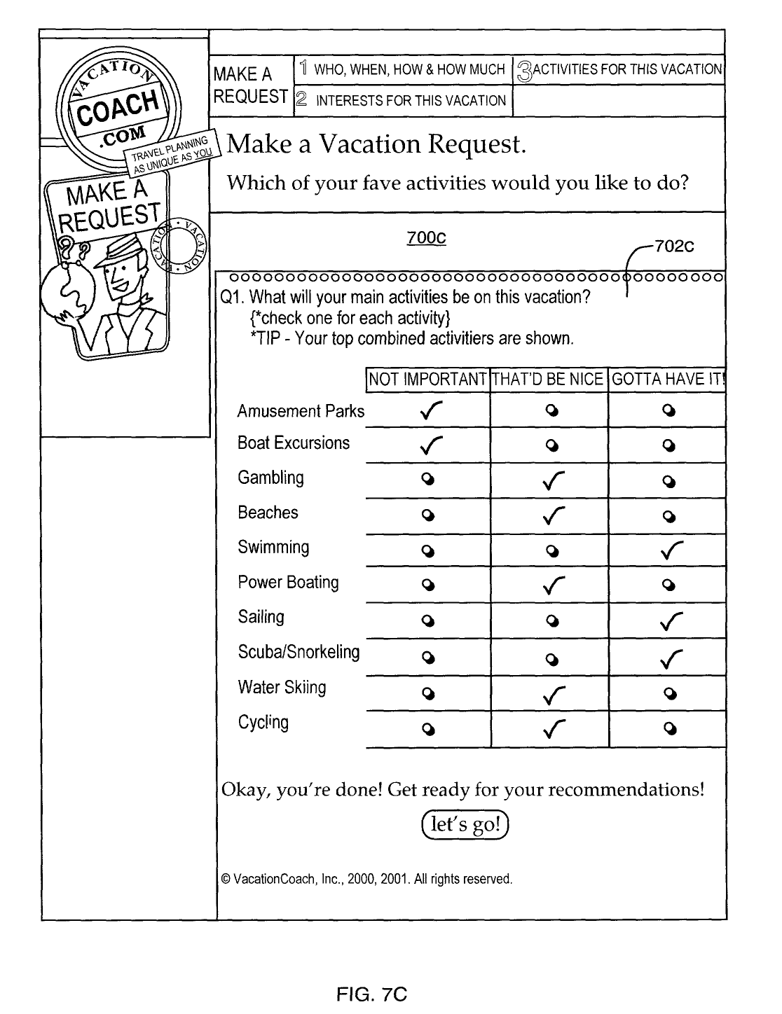

The user interfaces for making the vacation request are illustrated in the screen shots 700a, 700b and 700c of the FIGS. 7A through 7Cm, respectively. More specifically, some basic information is requested in screen shot 700b. Then, in screen shot 700b 9Fi.g 7B), a number of interests are listed in the chart 702b. The user can indicate with a check mark (by moving the cursor associated with the personal computer underneath the appropriate column) whether such interest is important for this particular vacation.

Information is next gathered concerning the activities for the vacation (636). The user is requested in step 638 to rate the top activities in accordance with importance. The user interface for this aspect of the invention is further illustrated in the screen shots 700cshown in FIG.7Cin which a number of activities are listed in the chart 700c. The user can move the cursor to indicate the importance level for each of the listed activities.

Filtering, Adjusting, and Scoring

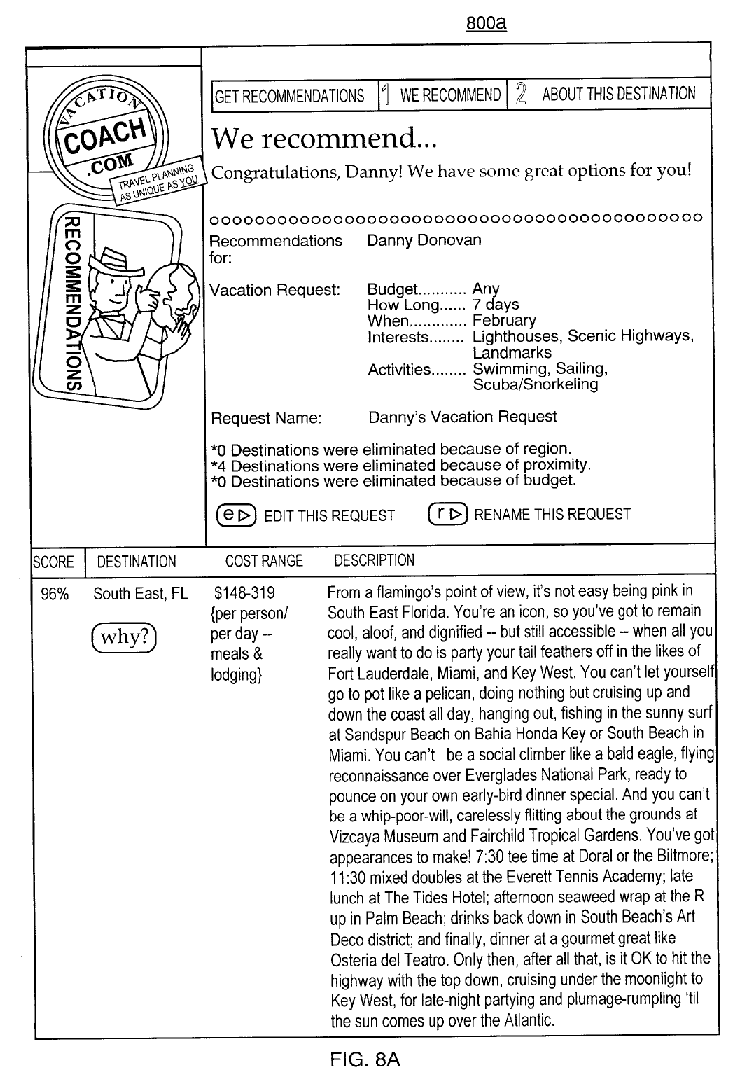

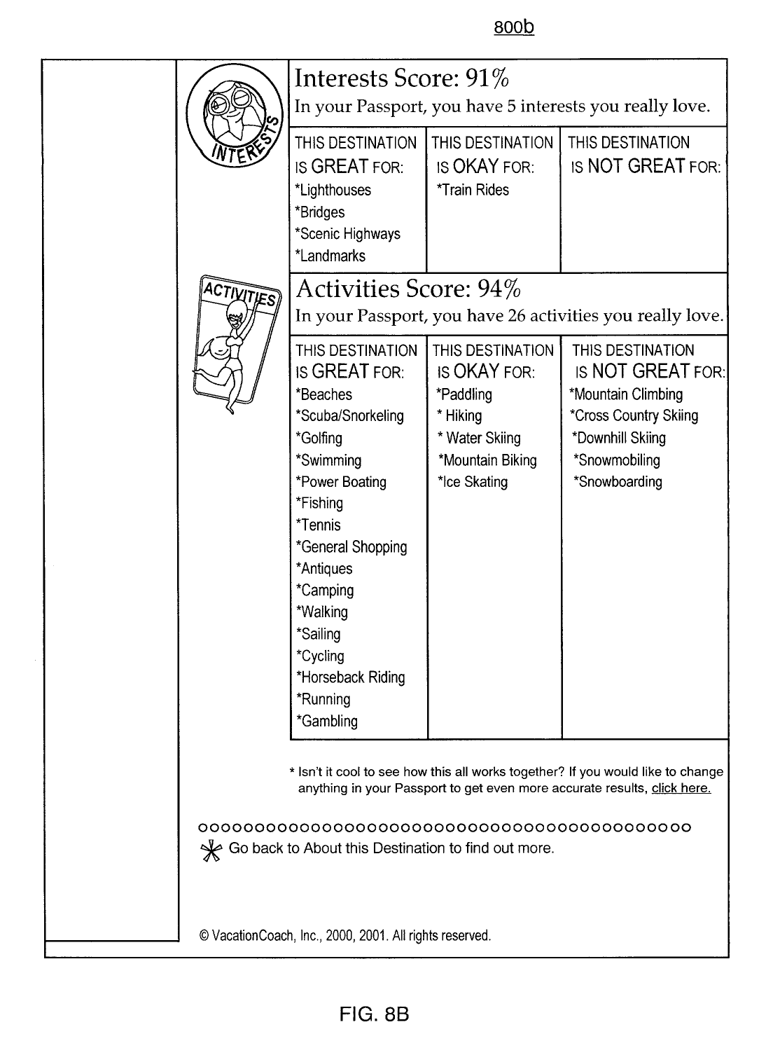

FIGS. 3A through 7C relate to gathering information from the user for the travel advice method and system of the present invention. Once this information has been gathered, the method of the present invention uses the information to score various destinations and rank those destinations. The destinations receiving the highest score are those destinations that most closely match the preferences indicated by the user. This is illustrated in the screen shots 800a and 800b of FIGS. 8A and 8B, respectively.

It should be understood that the user interfaces represented in the screen shots are illustrative of the lists of activities and interests, and user interfaces as provided in accordance with one embodiment of the invention. It should be understood that it is well within the scope of the present invention that other interests or activities may be added and some may be deleted from the lists and other user presentations and interfaces may be employed while remaining within the scope of the present invention.

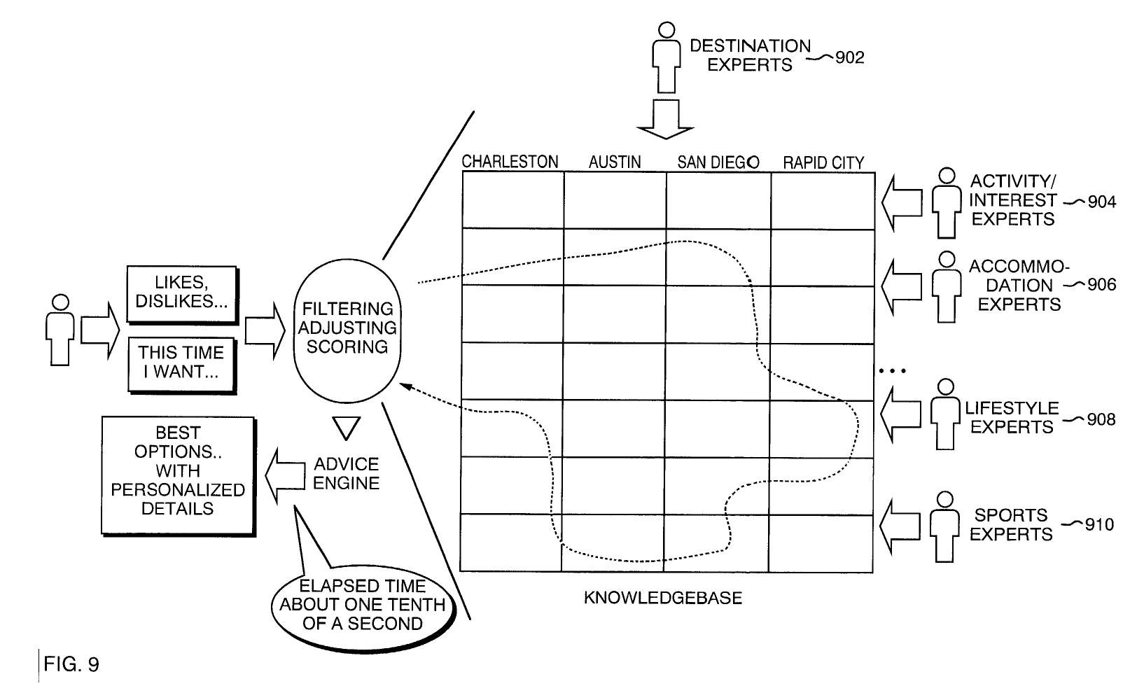

Referring now to FIG. 9, a knowledge base 900 includes the various sources of information in the system including destination expert information 902, activity/interest information 904, accommodation expert information 906, lifestyle expert information 908 and sport expert information 910. This information is mapped onto the various destinations, such as the cities shown in FIG. 9.

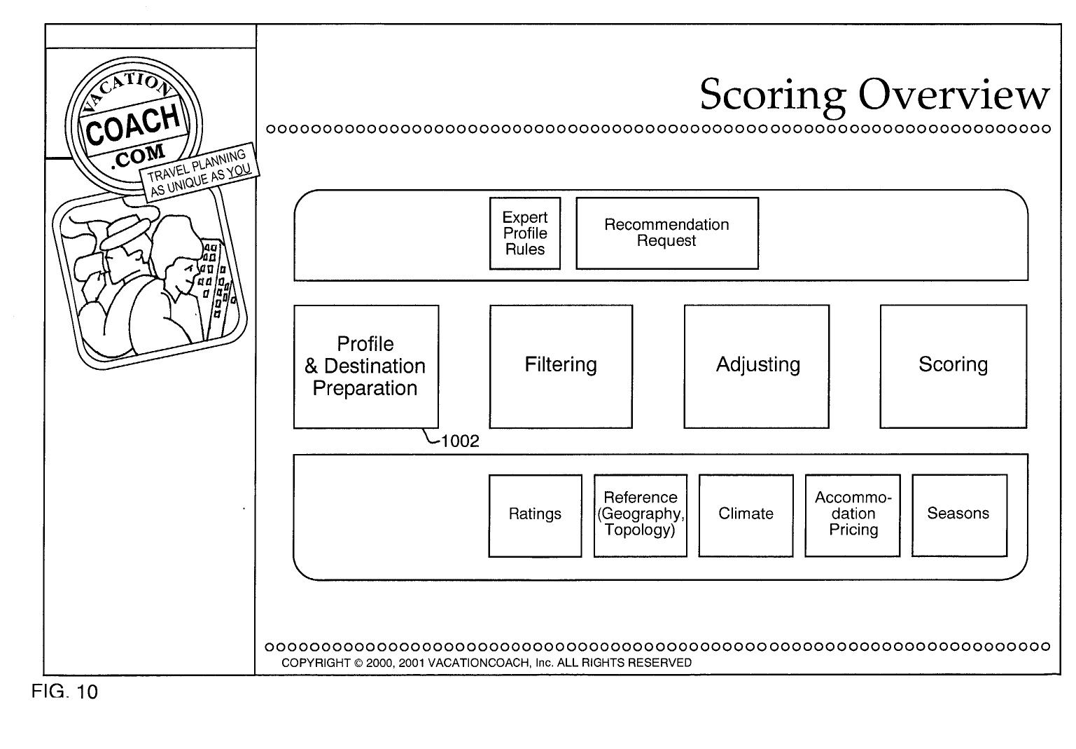

More specifically, referring to FIG. 10 the profile and destination preparation step 1002 uses the filtering, adjusting and scoring steps to combine the information about the individual and his/her request, as well as information about the destinations, such as ratings, reference information (such as geography and topology), climate information, accommodations, pricing and seasons, and other relevant information.

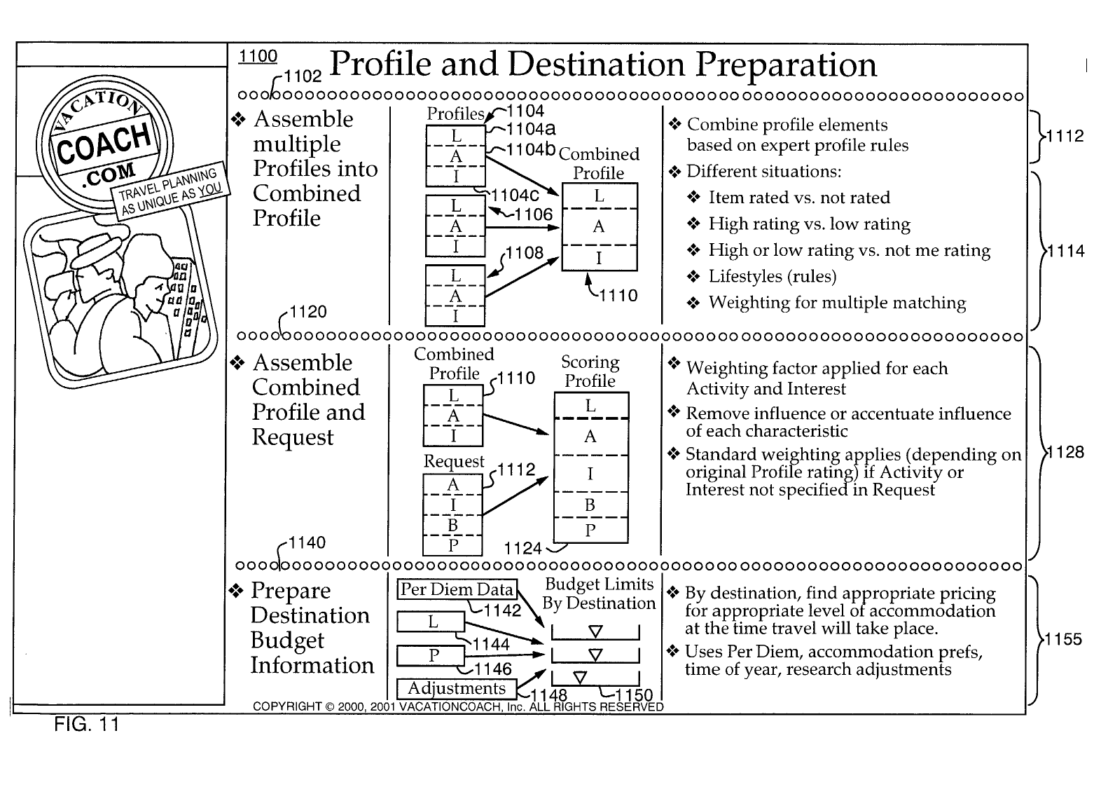

This information is combined and prepared as shown in greater detail in the chart 1100 of FIG. 11. Initially, profiles are assembled in block 1102. Multiple profiles are assembled into a single combined profile. The profile of a first individual is shown in block 1104, and it is combined with the profiles of other persons also traveling on this particular vacation, as shown in blocks 1106 and 1108. Each individual such as the individual profile 1104 has a lifestyle (L) rating, desired activities (A), and interests (I) as shown in blocks 1104a, b and c. The profiles 1104, 1106 and 1108 are assembled into a combined profile 1110. The combined profile includes a combination of the profile elements based on expert profile rules as shown in block 1112.

Various situations are taken into account in the assembly step, such as whether a particular item or an interest is rated versus not rated by the individuals. A high rating versus a low rating of a particular activity or interest is taken into account. A high/low rating versus a “not me” rating is also factored into the combination. For example, a “not me” rating may rule that particular item out for the group. Lifestyle rules are factored in (e.g., mountain climbing would not be recommended for infants and small children), and there is a weighting for multiple matching. In particular, if a number of parties indicated an interest in beaches then oceanfront destinations would receive a higher score than, for example, a woodland destination.

The next step, shown in block 1120, is to assemble the combined profiles and the request. The request includes lifestyle (L), activities (A), interests (I) and budget (B) at the particular destinations. These are assembled and combined, as shown in step 1120. The combined profile 1110 is added to the request 1220 to develop a scoring profile 1124. The scoring profile 1124 is derived using the weighting factors for each element. The next step is to remove influence or accentuate influence of each characteristic. A standard weighting applies, depending on the original profile rating if an activity or interest is not specified in the request, as illustrated in block 1128.

The destination budget information is prepared as shown on the chart at block 1140. Per Diem data 1142, lifestyle data 1144, and adjustments 1148 are taken into account to determine the budget limits by destination, 1150. Appropriate pricing is found for the desired level of accommodation at the time of travel. A per diem amount is used along with accommodation preferences, time of year and research adjustments from the database information. This is all taken into account as shown in block 1155.

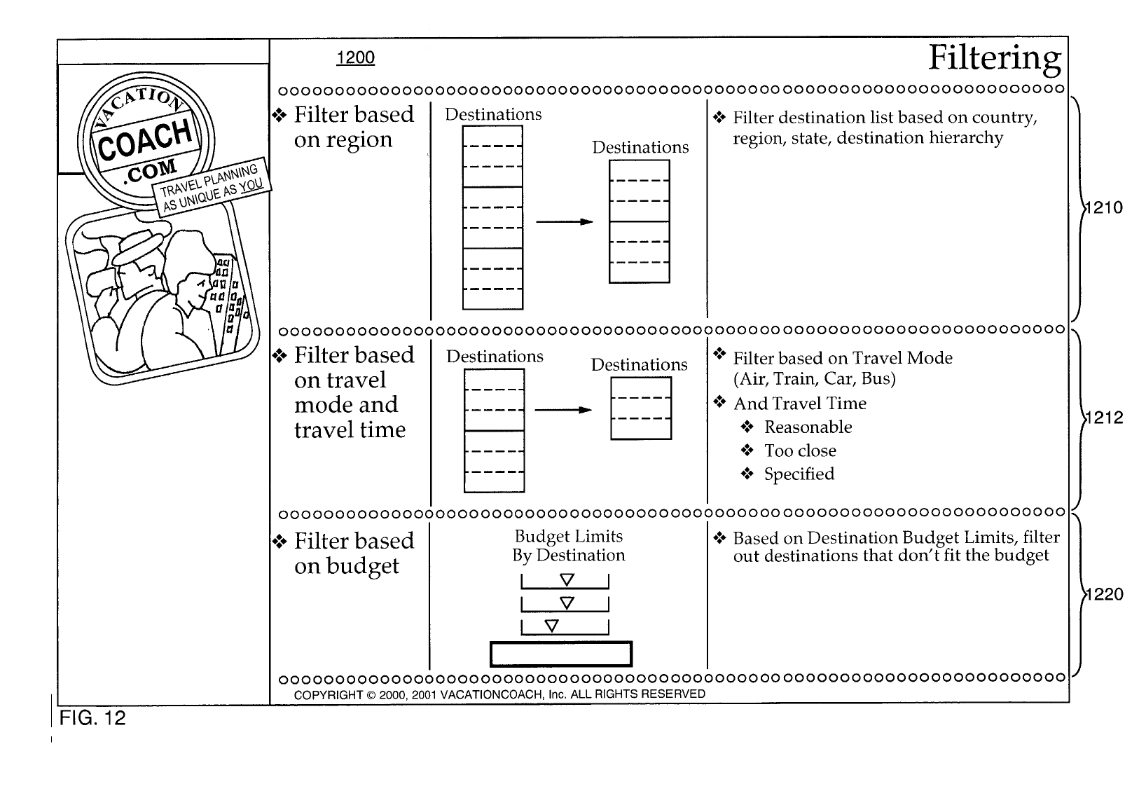

FIG. 12 illustrates the filtering step. Certain destinations are filtered out based on region, more specifically, the destination list is filtered based on country, region, state and destination hierarchy as shown in the block 1220 of the chart 1200. Destinations are filtered on travel mode and travel time, 1212. The filter is based on travel mode such as air, train, car or bus and whether this is feasible given the travel time. A filter is also used based upon destination budget limits to filter out destinations that do not fit the requested budget as shown in 1220 of chart 1200.

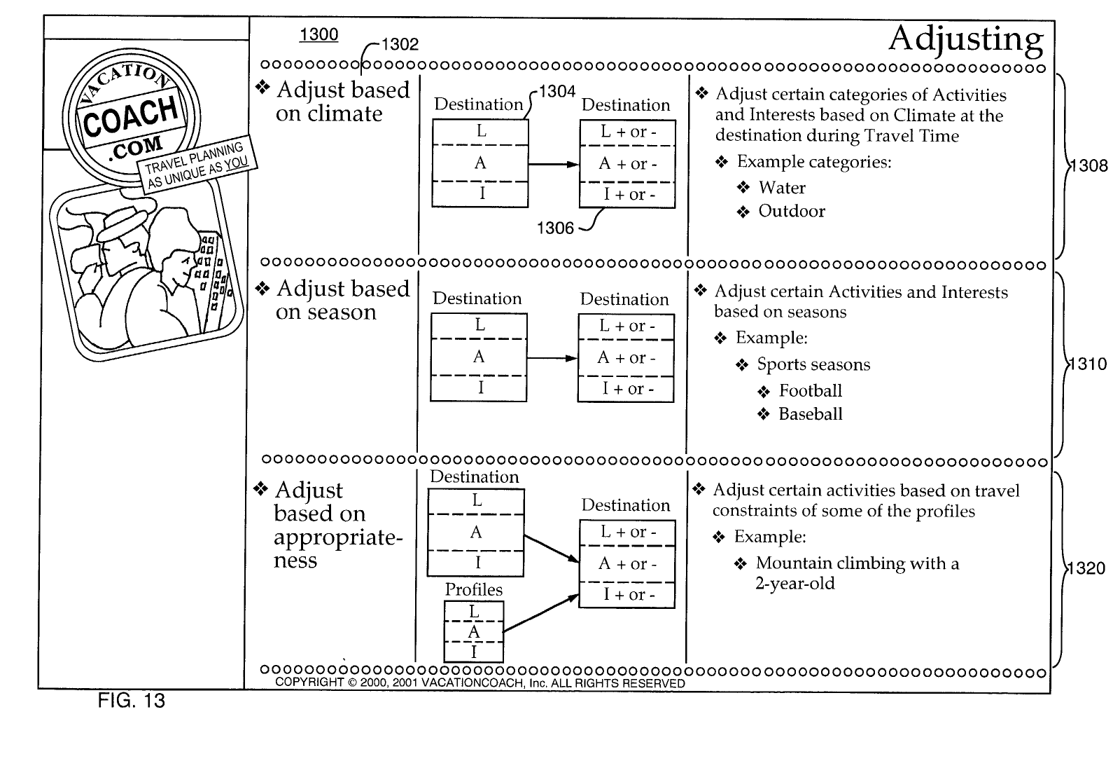

Next is the adjusting step, which is illustrated in the chart 1300of FIG. 13. The first step 1302 involves an adjustment based on climate. The destination scores 1304 are adjusted as shown in block 1306 based on climate at the destination during travel time. For example, water and outdoor activities require a certain outdoor temperature. Adjustments are also made based on season as shown in step 1310. Specifically, the destination score is adjusted up or down for certain activities based on season (e.g. sport seasons: football and baseball). The appropriateness of particular activities 1320 also is involved in an adjustment (e.g., gambling, casinos depend upon age range of group travelling). Also, the profiles are taken into account in this step, for example, the adjustments are made for certain activities based on travel constraints of some of the profiles. (For example, mountain climbing would not be recommended with a two-year-old).

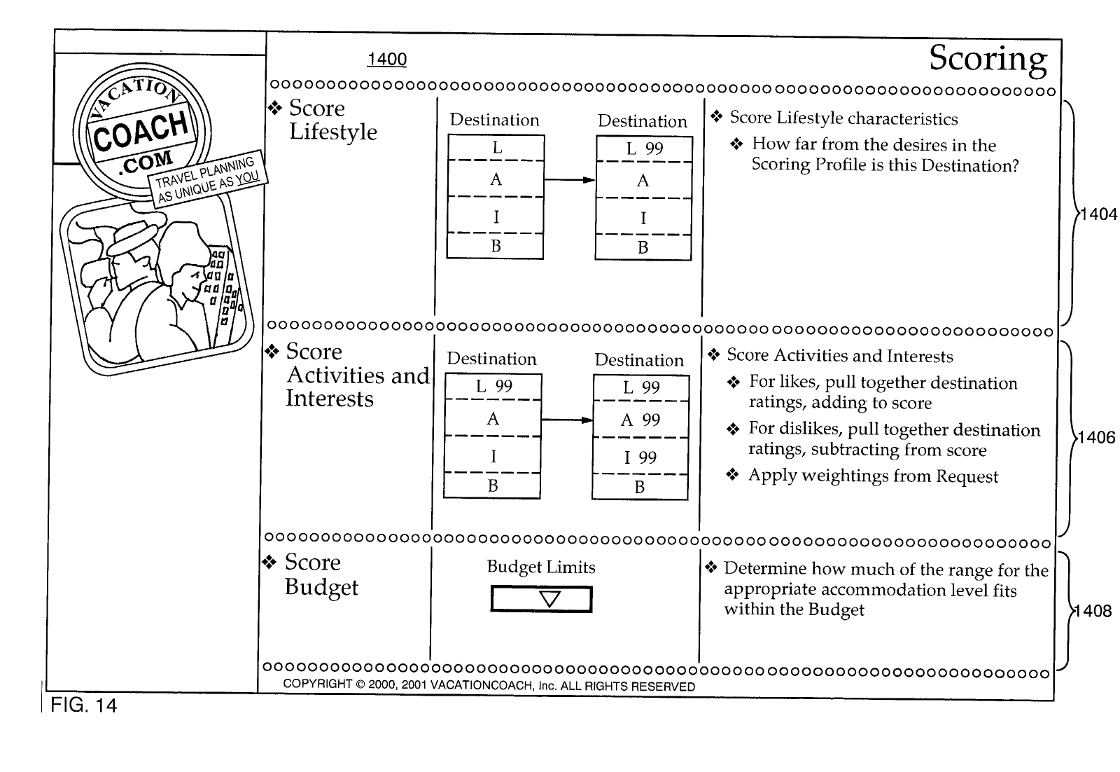

Scores are developed, as shown in the chart 1400 of FIG. 14. A lifestyle score is obtained by determining how far from the desires in the scoring profile is this particular destination, 1404. Activities and interests are scored. Destination ratings are assembled for “likes” and are added to the score, “dislikes” are subtracted from the score. Weightings from the vacation requests are applied, 1406. Budget limits are also scored to determine how much of the range for the appropriate accommodation level fits within the budget, 1408.

Using all of these scores, the best option with personalized details is produced by the advice engine as shown in block 950 of FIG. 9. This occurs within a lapse time of about 1/10 of a second 952.

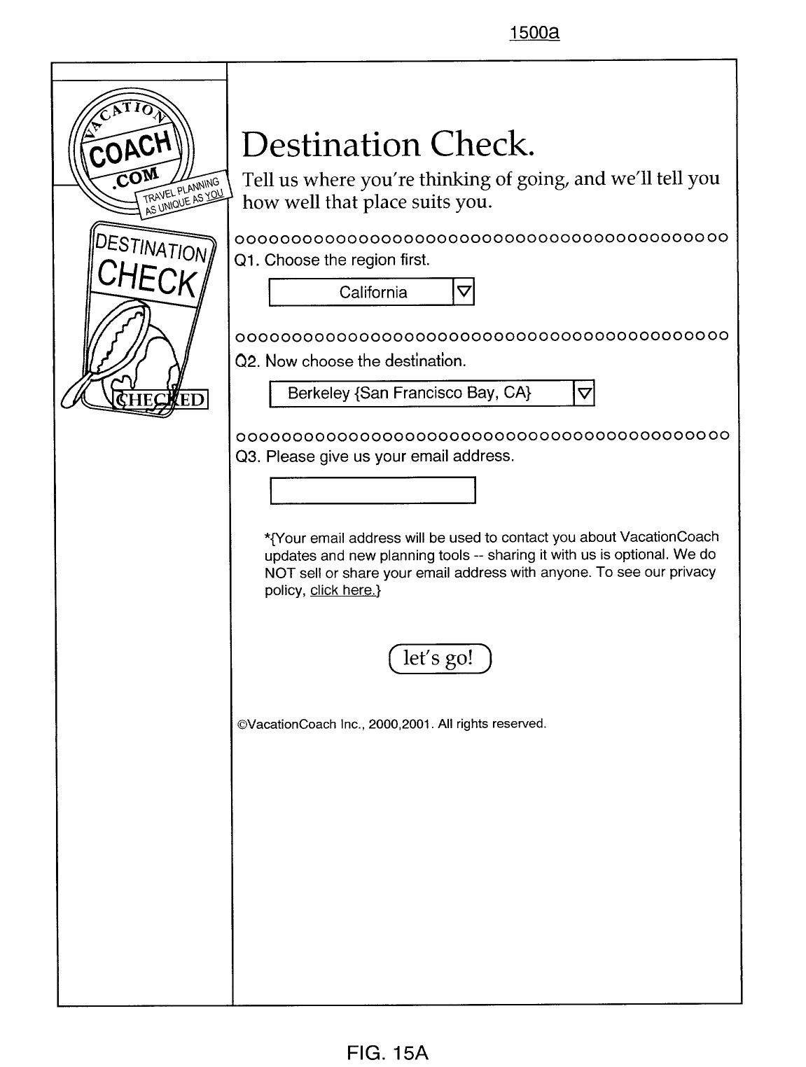

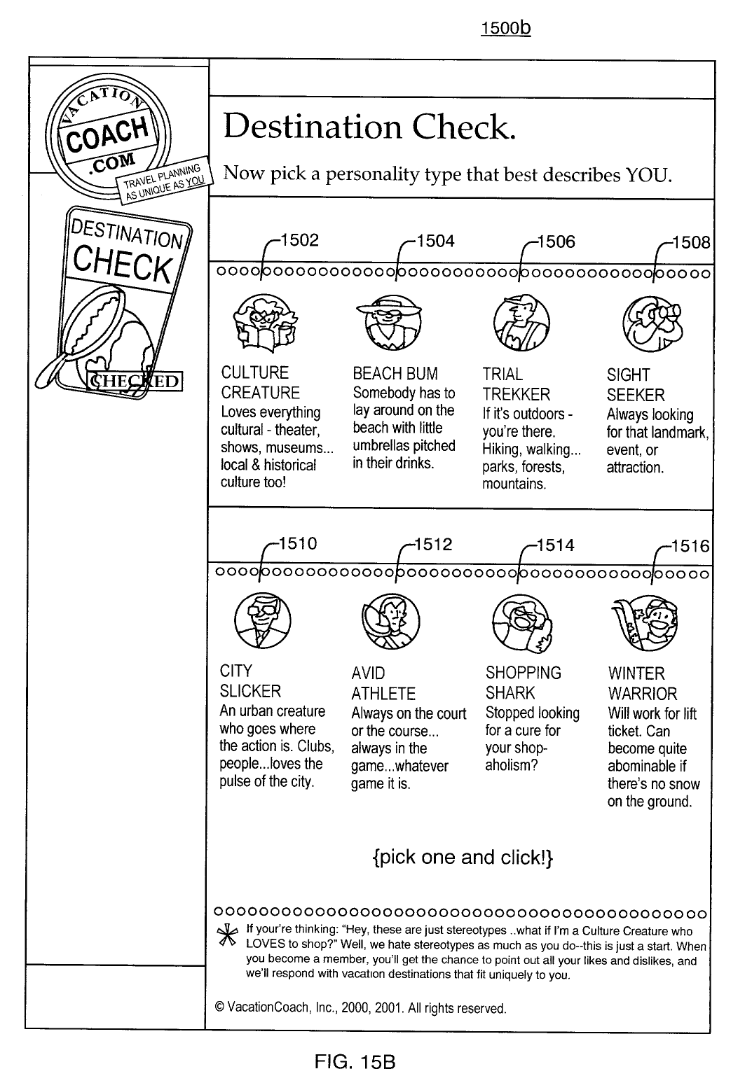

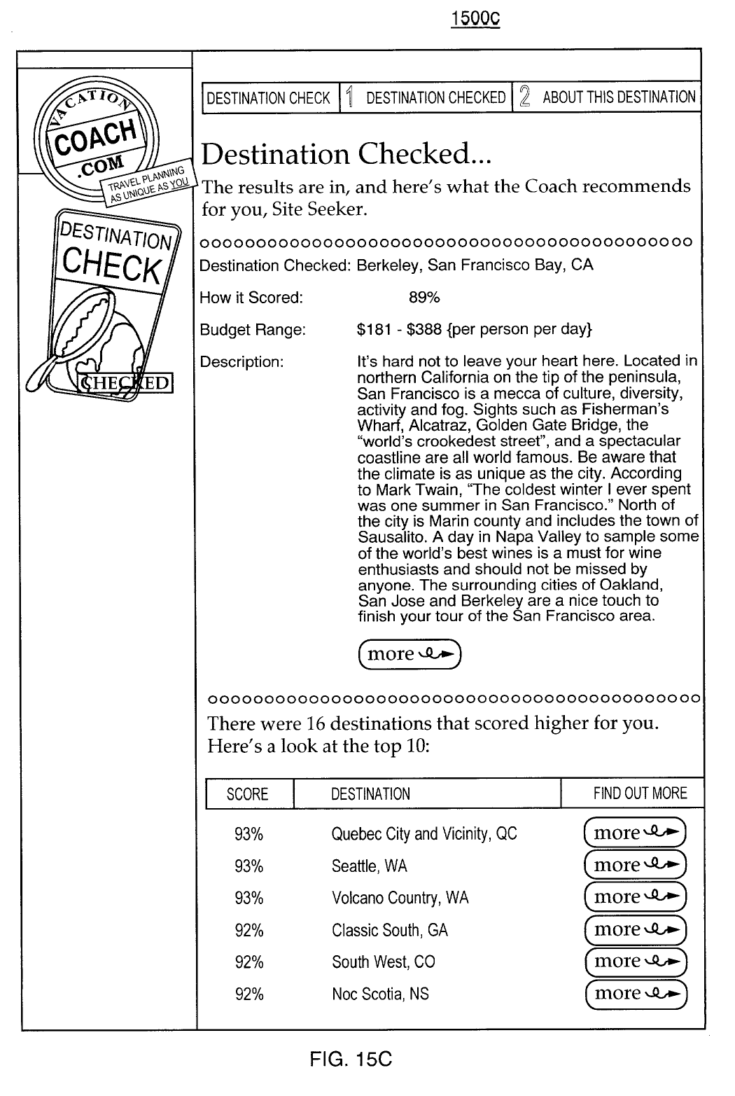

In addition to developing a list of vacation destinations that are recommended and associated rankings, the profiles and requests can be mapped onto a particular destination to determine whether that destination fits within an individual's profile and request. For this “Destination Check” mode, it is preferred to provide prescribed personalities that can be used for the profile information. The user interface to implement this mode of the invention is shown in FIG. 15A in which the user is prompted to insert a region and destination, 1500A. As illustrated in FIG. 15B, a set of personalities may include: culture creature 1502, beach bum 1504, trail trekker 1506, site seeker 1508, city slicker 1510, avid athlete 1512, shopping shark 1514 and winter warrior 1516. It should be understood that other personalities can be developed while remaining the scope of the present invention. A character such as culture creature 1502 is a short cut for the profile and it consists of a predefined set of ratings such as the profile 1104 of FIG. 11. This set of ratings is mapped onto the destinations to determine whether a particular destination would suit that personality. Alternatively, a member of the site who does have a profile can use the profile to map onto the destinations to check a particular destination to see if it would suit that individual. The results of the destination check are provided as shown in FIG. 15C, in which reasons are given about why the selected destination does or does not suit the profile of the user or the selected personality. Other destination that score even higher than the destination checked may also be provided as shown in FIG. 15C.

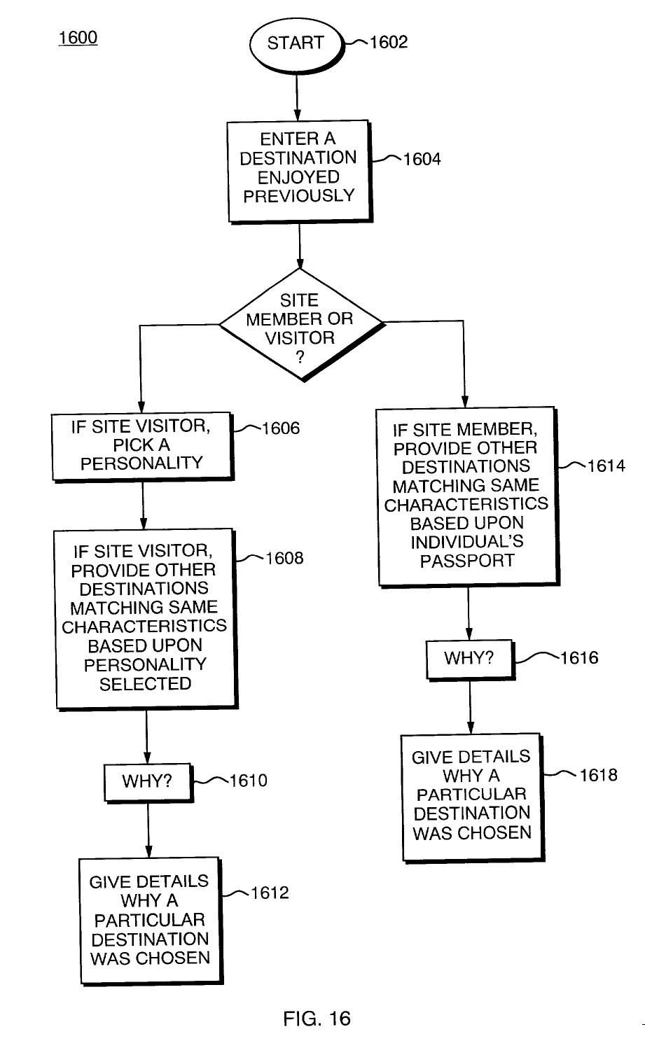

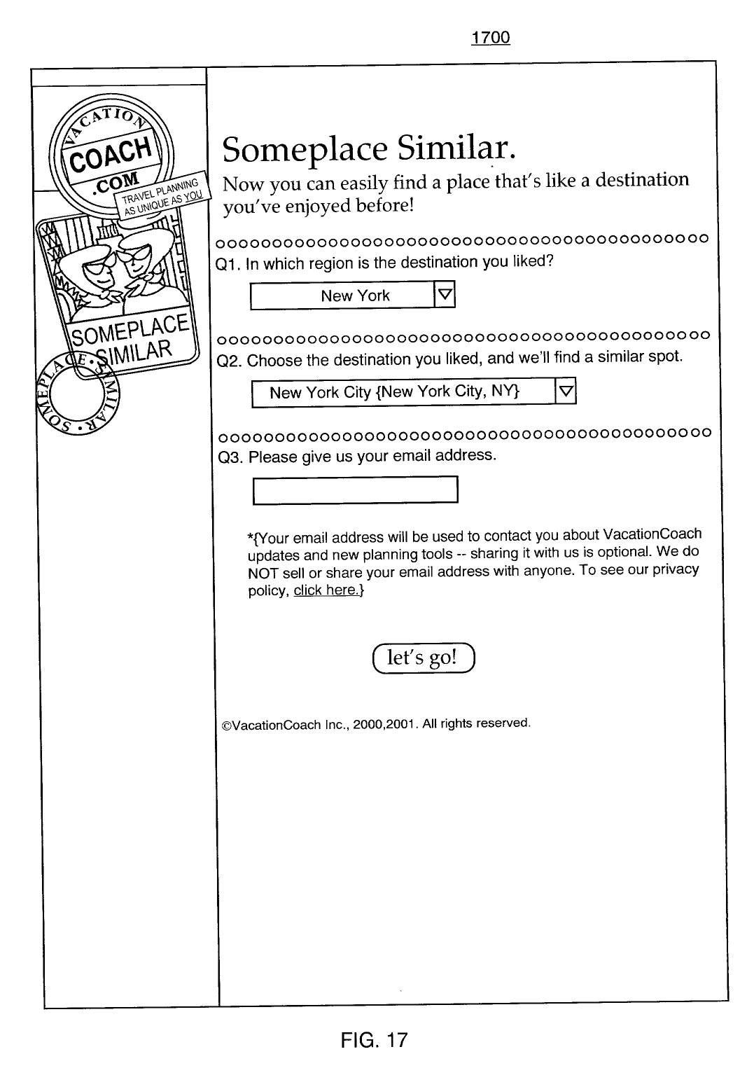

In accordance with yet a further aspect of the present invention, a user of the system may input a certain destination and request other destinations that would be similar in the “Someplace Similar” mode. This mode of the present system is illustrated in FIG. 16. Flow chart 1600 begins at the start step 1602 and the site user enters a destination enjoyed previously 1604. Depending on whether the user enters this page of the site as a visitor or a member, the decision tree can proceed from picking a personality such as just described for destination checks 1606. If the person using the site is a site visitor other destinations would be provided which match the characteristics based upon the personality selected as shown in step 1608. Steps 1610 and 1612 illustrate the feature that a user can select a Why? Button, and the system responds with details of why a particular destination was chosen as for that personality. The second path of the decision tree of the flow chart 1600 is for site members. If a site member chooses the Someplace Similar mode the system provides other destinations matching the same characteristics based on the individual's profile. As illustrated in 1616, 1618, the details about why a particular destination was chosen can be requested. A screen shot to begin this mode of the invention is provided in FIG. 17. The personality selection screen for step 1608 will be similar to that illustrated in FIG. 15B for the “Destination Check” function. The results will be display similar to that illustrated in FIG. 15C.

It should be understood that the method and system of the present invention can be used to obtain recommended travel destinations and can be used in a variety of ways to map out a personalized individual profile and a profile of a group of people traveling against a number of characteristics of various locations to determine suitable vacation destinations.

It should be further understood that the advice could be provided in a manner other than over the Internet as previously outlined. Moreover, not only may travel destinations be provided by the advice engine, but it can be readily adapted to provide hotel, restaurant as well as other leisure information to the user, based upon that users profile.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. A method of providing personalized travel advice over the Internet to a computer user, including the steps of:
(A) preparing a profile of personal travel preferences for an individual;
(B) preparing a travel request for an individual or group of individuals including profiles for said individual or group;
(C) combining a profile of at least one individual, with information obtained from said at least one individual concerning travel preferences for a particular travel arrangement to obtain a set of personalized scores;
(D) mapping said personalized scores onto a database of expert information concerning destinations; and
(E) matching characteristics of those destinations with said at least one profile and travel request to produce a list of recommended travel destinations.

2. The method as defined in claim 1, including, when preparing a profile, the further step of:
providing a series of questions for said individual to answer on subject matters including lifestyle, activities and travel interests.

3. The method as defined in claim 2, including the further step of:
combining profiling elements with information received from said individual, wherein said profiling elements include travel expert characteristic knowledge.

4. The method as defined in claim 1, including the further step of:
providing vacation request queries for said individual on subject matters including activities and interests.

5. The method as defined in claim 4, including the further step of:
providing as one of said vacation request queries a sliding scale allowing a rated response for each activity and interest.

6. The method as defined in claim 1, including the further step of combining information received from said individual with the following information:
(A) travel expert advice characteristics;
(B) leisure advice rules; and
(C) real world knowledge;

7. The method as defined in claim 1 including the further step of: combining information received from said individual with information including at least one of the following:
(A) travel expert destination knowledge;
(B) factual data;
(C) activity and interest expert information; and
(D) activity and interest knowledge

8. The method as defined in claim 1, including the further step of:
scoring said individual responses and information obtained from said individual by assigning each parameter a particular value.

9. The method as defined in claim 8, including the further step of:
filtering destinations based upon selections made by said individual.

10. The method as defined in claim 9, including the further step of said filtering based upon geographic region.

11. The method as defined in claim 9 wherein said filtering step includes filtering based upon travel mode.

12. The method as defined in claim 9 including said filtering step having said filter based upon travel time.

13. The method as defined in claim 9 including said filtering step including said filtering step including a filter being based upon a budget.

14. The method as defined in claim 8 included the further step of:
adjusting said values determined in said scoring step for various categories including those of climate, season and travel constraints.

15. The method as defined in claim 14 including the further step of:
mapping a particular destination against the profile of an individual to determine the extent to which the chosen destination compares with the individual's scoring results.

16. The method as defined in clam 14 including the further step of:
providing prescribed personalities that are predefined full profiles that fit a particular personality type design.

17. The method as defined in claim 16 including the further step of:
mapping a particular destination selected by an individual user against the scores of the prescribed personality.

18. The method as defined in claim 10 including the further step of:
mapping a selected destination to other destinations to produce a list of similar destinations.

19. The method as defined in claim 18 including the further step of:
providing a prompt for selection by a user to obtain details of why a particular destination was chosen.

20. The method as defined in claim 18 wherein
said predetermined personalities are provided for selection by the user for obtaining destinations comparing favorably to characteristics based on the prescribed personality.

21. The method as defined in claim 1 wherein two or more individuals are requesting advice for travelling as a group, said method including the further step of:
(A) preparing a profile for each member of the group; and
(B) combining the profiles for each member of the group and the request to produce travel recommendations which best match the preferences of the group.

22. A system for providing personal travel advice to a user, comprising:
(A) a travel advice server including an information storage device, a central processing unit controlled by an associated clock, a communications port and a destination storage device including:
(1) a profiling engine for preparing a profile of an individual user based upon the user input regarding travel characteristics and preferences; and
(2) an advice engine that accesses a destination base, database and a database of expert knowledge to provide travel advice and recommendations based upon said individual profile produced by said profiling engine, and the information in said destination database and said expert knowledge database;
(B) Internet service provider interface; and
(C) personal computer coupled with said Internet service provider interface, which in turn communicates with, said server through which personalized travel advice is provided to said user via a personal computer.

23. The system as described in clam 22, wherein
said profiling engine includes means for producing a user interface on said personal computer using which information may be obtained from said user by said user moving a cursor associated with said personal computer along a sliding scale to indicate the degree to which said user evaluates a particular parameter related to travel.

24. The system as provided in claim 22 in which said advice engine includes:
means for producing a user interface which displays a slider bar under which pointers may be placed by said user via a cursor associated with said personal computer to determine the level of importance of certain interests and activities to said user or a particular travel arrangement.

25. The method as defined in claim 22 wherein
said profiling engine includes means for producing a user interface which displays a table under which indicators can be moved by said user to indicate the importance of interests the user may have in a particular circumstance.

26. A method of providing personalized travel and leisure advice to a user, including the steps of:
(A) preparing a profile of personal travel and leisure preferences for and individual;
(B) obtaining a request from said individual for a specific instance of travel or leisure pursuits;
(C) combining said profile and said request for said individual to obtain a set of personalized scores;
(D) mapping said set of personalized scores onto a database of expert information concerning travel and leisure;
(E) matching characteristics of travel and leisure items with said individual's profile and request to produce a personalized list of recommended travel and leisure pursuits for that individual.

27. The method of claim 26 wherein a group of individuals make a request, and wherein said method includes the further step of:
(A) preparing a profile for each of individual;
(B) combining the profiles of the individuals and the request; and
(C) mapping the combined profiles and the request onto said database of expert information to produce the optimum result for the group.
